(19) United States
(12) Patent Application Publication
(10) Pub. No.: US 2019/0047523 A1
(43) Pub. Date: Feb. 14, 2019

(54) Car Wash System Integrated with Automated Parking Structure

(71) Applicant: Chang Yup Lee, Los Angeles, CA (US)

(72) Inventor: Chang Yup Lee, Los Angeles, CA (US)

(21) Appl. No.: 15/713,528

(22) Filed: Sep. 22, 2017

Related U.S. Application Data
(60) Provisional application No. 62/544,732, filed on Aug. 11, 2017.

(51) Int. Cl. B60S 3/00; B60S 3/04

(52) U.S. Cl. CPC B60S 3/004; B60S 3/002; B60S 3/04

(57) ABSTRACT

An automated parking structure includes a car load bay, a plurality of parking stalls, a car wash compartment, a transport mechanism transporting a car to a designated location in the parking structure and a pallet that is adapted to carry a car thereon. The designated location includes the car load bay, one of the parking stalls and the car wash compartment. The transport mechanism includes a horizontal transport device that transports the pallet horizontally, and a vertical transport device that transports the pallet vertically. The horizontal transport device moves the pallet into and out of the car wash compartment.

### CROSS-REFERENCE TO RELATED APPLICATIONS

This application claims priority on the inventor's Provisional Application No. 62/544,732 filed on 11 Aug. 2017, the disclosure of which is incorporated by reference as if fully set forth herein.

### BACKGROUND OF THE INVENTION

### 1. Field of the Invention

The present invention is related to a car wash system that is integrated with car moving and storing mechanism of an automated mechanical parking structure. More particularly, the present invention is related to a car wash system that is integrated with an automated mechanical parking structure in terms of vehicle transport and control of the system.

### 2. Discussion of Related Technology

An automated mechanical parking structure is important part of urban life. It saves the limited space in a metropolitan area and provides convenience and flexibility in time and location for car drivers. The fact that many cars are stored for extended time in a single location is appropriate to integrate essential functions to the structure. Further, the parking structure provides variety of automated functions. A car wash facility that effectively utilizes the concentration of cars in a parking structure, and merging with the mechanism of the parking structure has long been in need. The foregoing discussion in this section is to provide general background information, and does not constitute an admission of prior art.

### SUMMARY OF THE INVENTION

The present invention provides a fully automated mechanical parking system integrating automated unmanned car wash system capabilities. The system can be programmed at the entry recognition point to have the capabilities of parking the car into the fully automated parking facility with the programmed option of automatic unmanned car wash at the designated time requested at the entry recognition control panel by the system user. This combined system uses the automated mechanical parking system utilizing the pallet system and pallet transfer mechanism to move the pallet in and out of the car wash room from the load bay once the car is in the load bay and upon verification with infrared and motion sensors of safe exit of person(s) and pet(s) out of the load bay. A serviced vehicle (washed car) can be retrieved at the entry recognition control panel and exit from the load bay(s) same way as the normal retrieval of parked cars from the automated parking system.

An objective of the invention is to provide a car wash system fully integrated with the automatic functions of a parking structure.

In order to achieve the objective, the present invention provides an automated parking structure comprising a car load bay, a plurality of parking stalls, a car wash compartment, a transport mechanism transporting a car to a designated location in the parking structure and a pallet that is adapted to carry a car thereon. The designated location comprises the car load bay, one of the parking stalls and the car wash compartment.

The transport mechanism comprises a horizontal transport device that transports the pallet horizontally, wherein the horizontal transport device moves the pallet into and out of the car wash compartment, and a vertical transport device that transports the pallet vertically.

The car load bay comprises an entry recognition device that is adapted to recognize a car entering the automated parking structure, and to receive input from a driver of the car, wherein the input comprises a car cleaning command.

If the entry recognition device receives a car cleaning command, a sequence of the designated locations for the transport mechanism comprise a sequence of the car wash compartment, the parking stall and the load bay, or a sequence of the parking stall, the car wash compartment, the parking stall and the load bay, or a sequence of the parking stall, the car wash compartment and the load bay. The sequence is determined depending on the availability of the car wash compartment and parking time of the car. Alternatively, the sequence is determined by the input at the entry recognition device, whereby the driver of the car can choose the time of washing the car.

The transport mechanism starts to move the car toward the designated location after checking the occupant of the car exits out of the load bay. The car wash compartment comprises a floor on which the pallet moves, a car washing mechanism and a drying mechanism, wherein a pallet track rail, along which the pallet moves, is provided on the floor. The washing mechanism and the drying mechanism are spaced from the pallet when the pallet is in the car wash compartment whereby the washing mechanism and the drying mechanism do not interfere with the movement of the pallet.

The transport mechanism further comprises a shuttle on which the pallet is placed. The car wash compartment further comprises a motor for driving the shuttle.

The car wash compartment further comprises a car wash entrance door. The car washing mechanism comprises a touchless wash system. Alternatively, the car washing mechanism comprises a friction wash system, which comprises a top cloth brush, two side cloth brushes and a tire brush.

The car wash compartment further comprises a sensor that senses whether the pallet is secured in the car wash compartment.

The car wash compartment further comprises a car wash detergent tank, a detergent mixer, a water tank, a pump assembly for spraying water, a car wash control panel, an air compressor, a water reclamation and filtration system.

The advantageous effects of the present invention are: (1) the service of the parking structure is increased giving more motivation to use the structure to car drivers; (2) moving the vehicle inside the car wash compartment is simplified because it is performed by the transport mechanism used for the parking structure; (3) the operation time of car wash compartment is optimized and maximized.

### BRIEF DESCRIPTION OF THE DRAWINGS

The accompanying drawings illustrate the best embodiments of the present invention. In the drawings:

FIG. 1 is a schematic perspective view showing a car wash system integrated with automated parking structure according to the present invention;

FIG. 2 is a schematic plan view a touchless car wash system;

FIG. 2a is a schematic plan view showing a friction car wash system;

FIG. 3 is a schematic elevation view showing lift action for parking;

FIG. 4 is a schematic perspective view showing integration of a car wash system into an automated mechanical parking system;

FIG. 5 is a schematic perspective view showing that a car enters a load bay;

FIG. 6 is a schematic perspective view showing that a car is transported on the lift;

FIG. 7 is a schematic perspective view showing that a car is placed in a car wash room via pallet transfer mechanism;

FIG. 8 is a schematic perspective view showing that a car is cleaned by facilities of the car wash room;

FIG. 9 is a schematic perspective view showing that a car is moved back from the car wash room;

FIG. 10 is a schematic perspective view showing that a car is lifted in the mechanical parking structure;

FIGS. 11 and 12 are schematic perspective views showing that a car is transported to a designated parking stall; and

FIG. 13 is a schematic perspective view showing that a car exits from the load bay.

### DESCRIPTION OF PREFERRED EMBODIMENTS

Embodiments will be described in detail below. The accompanying drawings will be used for describing embodiments. For the sake of convenience of illustrating embodiments, thickness, length, diameter, size and other dimensions of components would be illustrated or exaggerated to be different with those of actual components, and the subject matter of this application is not limited to the illustrated embodiments.

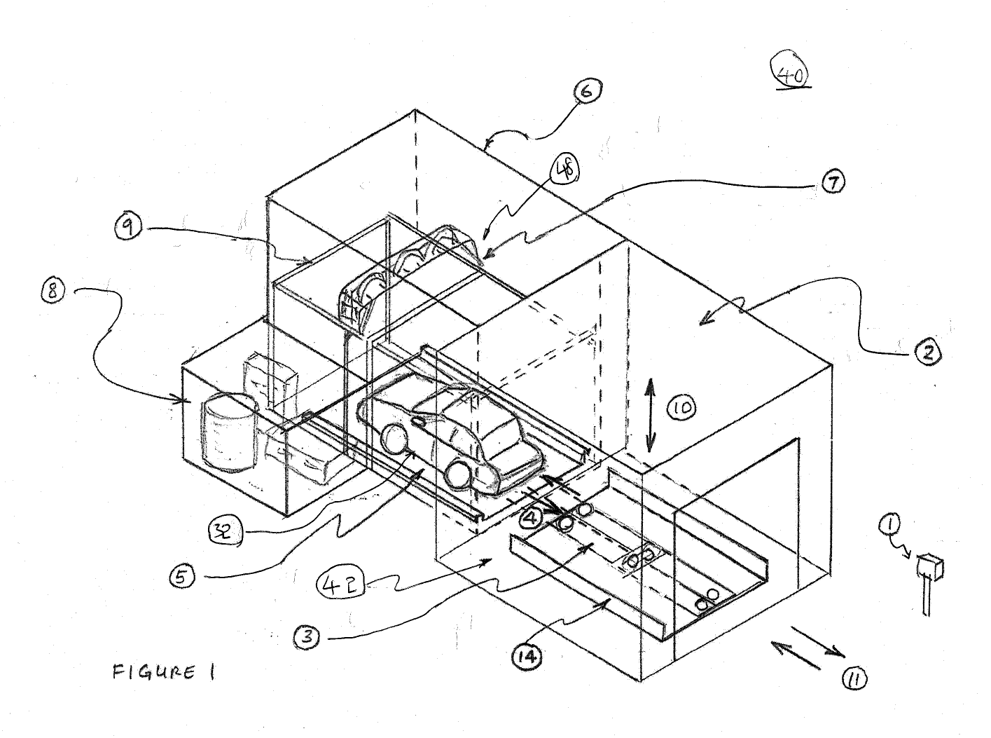

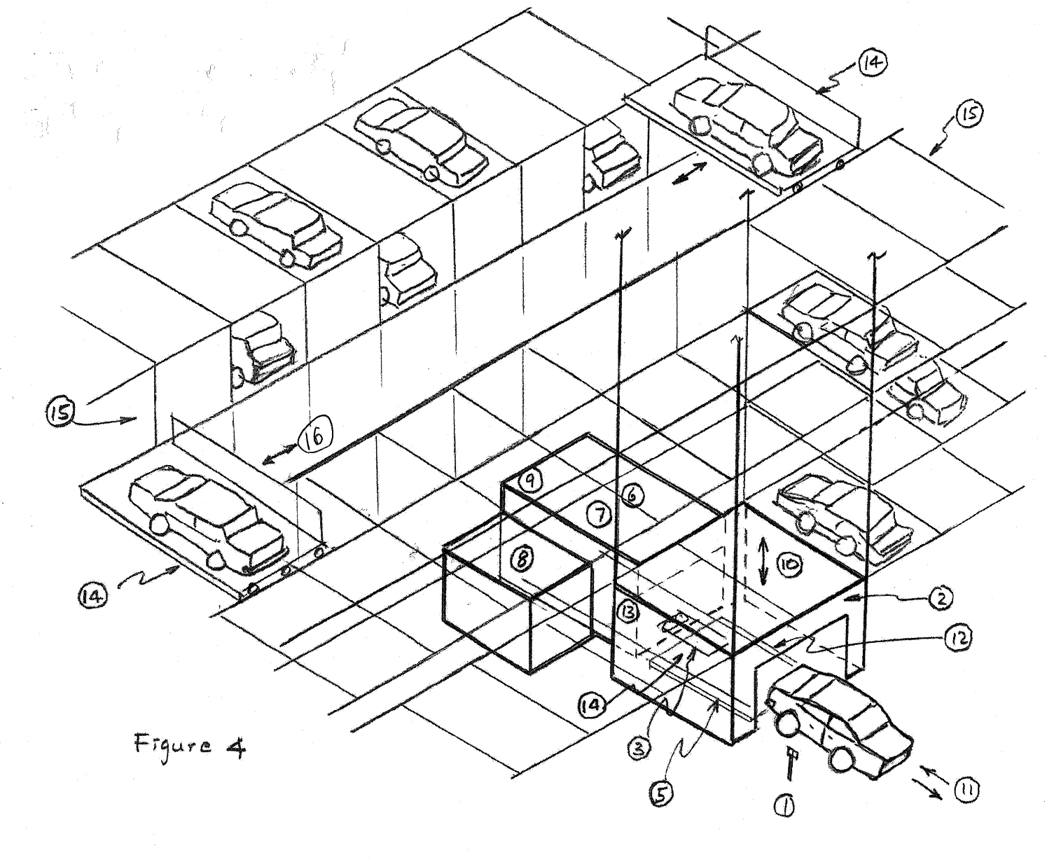

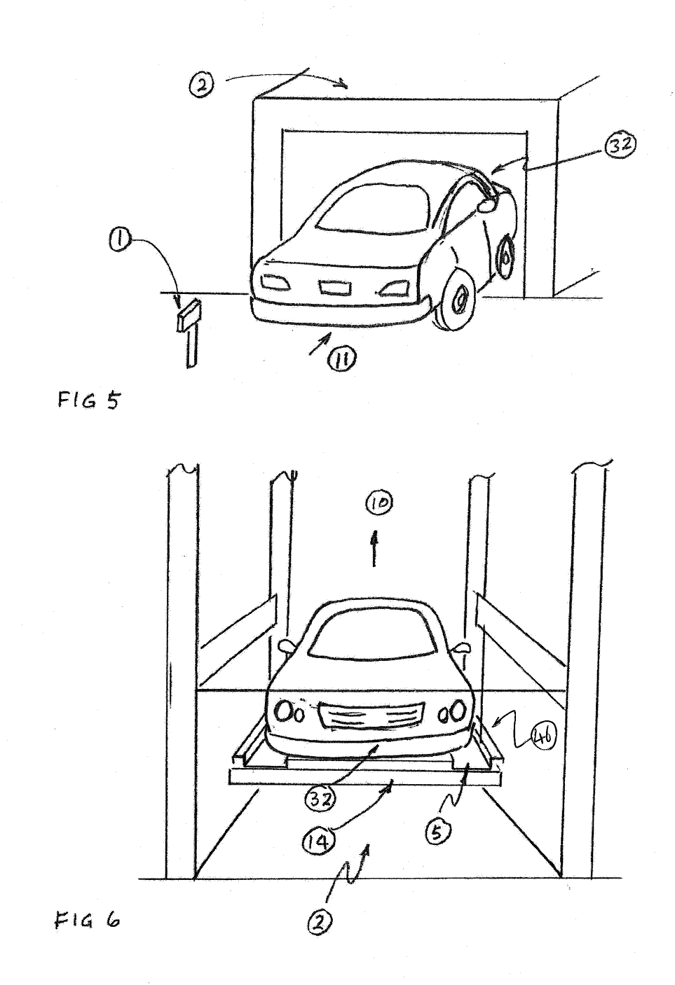

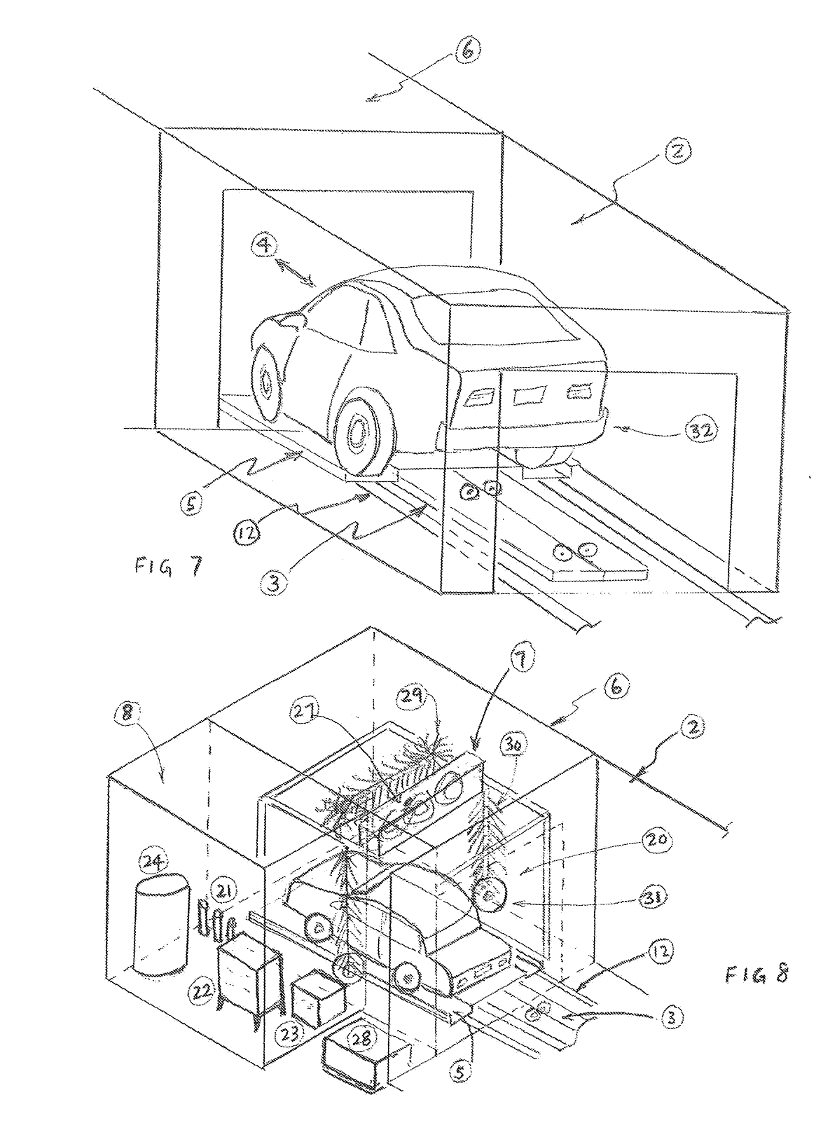

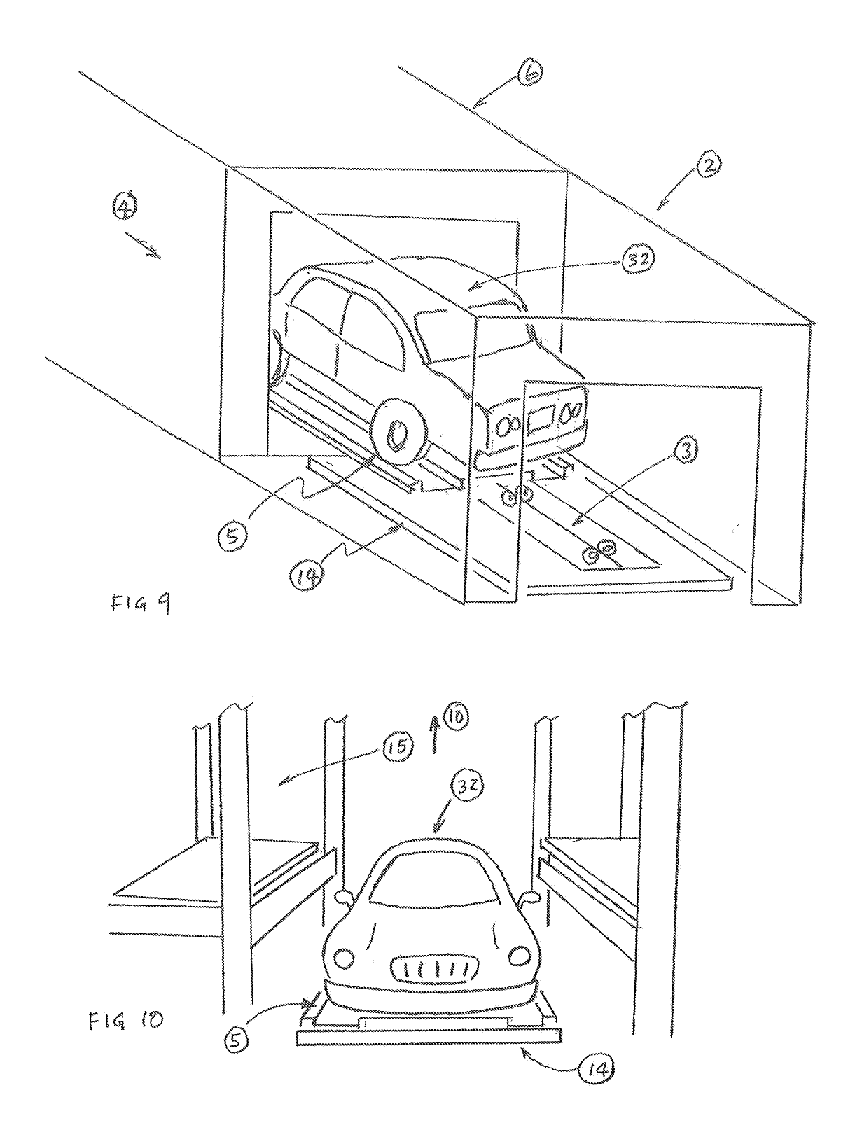

Referring to FIG. 1, an automated parking structure 40 comprises a car load bay 2, a plurality of parking stalls 15 or cells (refer to FIG. 4), a car wash compartment 6, a transport mechanism 42 transporting a car 32 to a designated location in the parking structure 40 and a pallet 5 that is adapted to carry a car 32 thereon. The designated location comprises the car load bay 2, one of the parking stalls 15 and the car wash compartment 6.

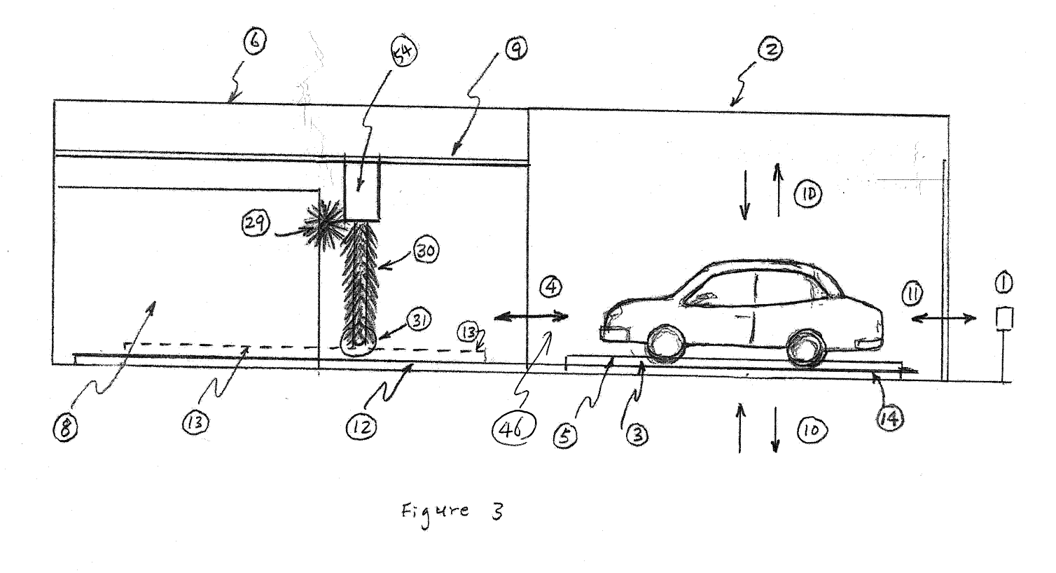

Referring to FIG. 3, the transport mechanism 42 comprises a horizontal transport device 3 that transports the pallet 5 horizontally, wherein the horizontal transport device 3 moves the pallet 5 into and out of the car wash compartment 6 as indicated by the arrows 4. Referring to FIG. 6, the transport mechanism 42 further comprises a vertical transport device 46 that transports the pallet 5 vertically. Referring to FIGS. 3 and 4, arrows 10 indicate the vertical transportation (fully automated parking system lift (elevator) function—up or down (above or subterranean).

Referring to FIGS. 1, 3 and 4, the car load bay 2 comprises an entry recognition device 1 that is adapted to recognize a car 32 entering the automated parking structure 40, and to receive input from a driver of the car 32, wherein the input comprises a car cleaning command. The entry recognition device 1 may be a key pad or a card swipe device.

If the entry recognition device 1 receives a car cleaning command, a sequence of the designated locations for the transport mechanism 42 comprise a sequence of the car wash compartment 6, the parking stall 15 and the load bay 2, or a sequence of the parking stall 15, the car wash compartment 6, the parking stall 15 and the load bay 2, or a sequence of the parking stall 15, the car wash compartment 6 and the load bay 2. That is, car washing occurs just after the car 32 enters the parking structure 40 and before the car 32 is stored in the designated stall 15, sometime during the storage of the car 32 in the parking structure 40, or just before the car 32 exits the structure 40 thorough the load bay 2. The automatic function of the transport mechanism 42 intellectually controlled by a controller (not shown) of the parking structure 40 and the automatic function of the car wash compartment 6 perform this unmanned car storage and car wash. Referring to FIG. 1, arrows 11 indicate entry/exit of the car from the load bay 2.

The sequence is determined depending on the availability of the car wash compartment 6 and parking time of the car 32 by the controller of the parking structure 40. The availability of the car wash compartment 6, and the occupancy or vacancy of the stalls 15 are continually monitored by the controller.

Alternatively, the sequence is determined by the input at the entry recognition device 1. That is, the driver of the car 32 can choose the time of washing the car 32 considering the expected parking time of the car 32.

The transport mechanism 42 starts to move the car 32 toward the designated location after checking the occupant of the car 32 exits out of the load bay 2.

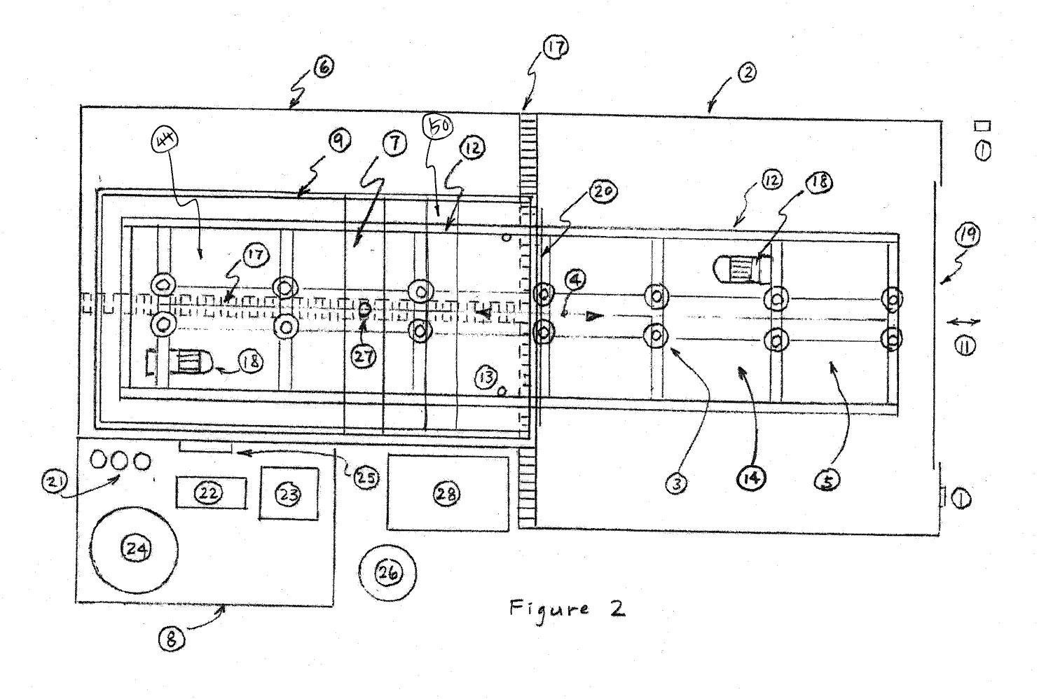

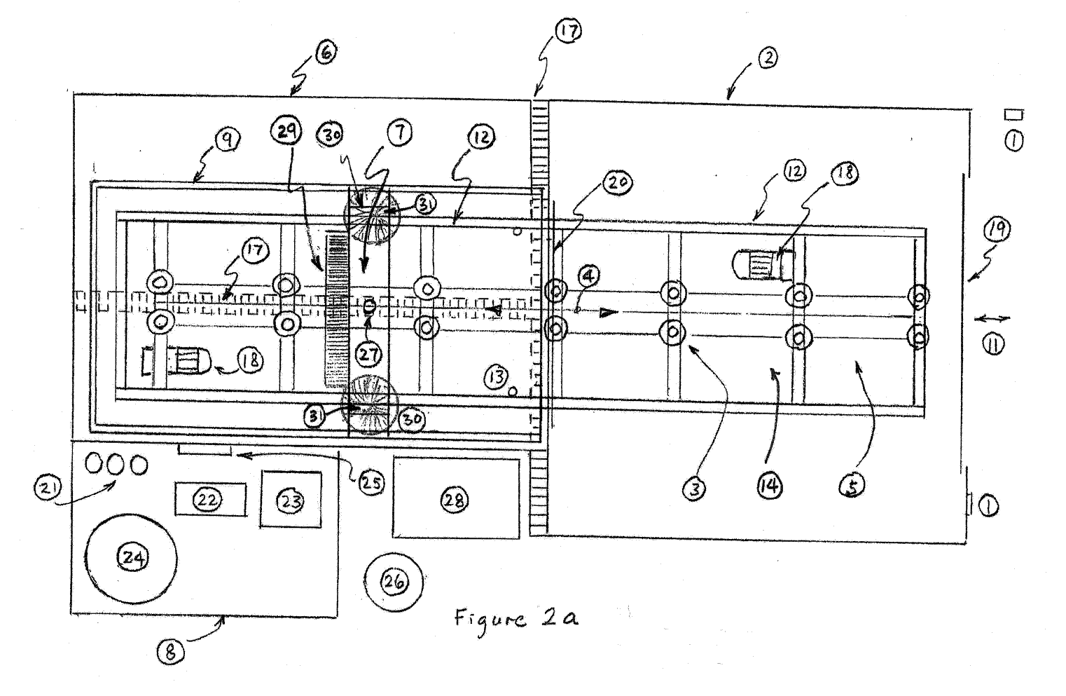

Referring to FIGS. 1 and 2, the car wash compartment 6 comprises a floor 44 on which the pallet 5 moves, a car washing mechanism 48 and a drying mechanism 50. A pallet track rail 12, along which the pallet 5 moves, is provided on the floor 44.

The washing mechanism 48 and the drying mechanism 50 are spaced from the pallet 5 when the pallet 5 is in the car wash compartment 6 whereby the washing mechanism 48 and the drying mechanism 50 do not interfere with the movement of the pallet 5.

Referring to FIG. 1, the transport mechanism 42 further comprises a shuttle 14 or a transfer cart on which the pallet 5 is placed. Referring to FIG. 2a, the load bay 2 comprises a load bay entrance door 19.

Referring to FIG. 2, the car wash compartment 6 further comprises a motor 18 for driving the shuttle 14, and a car wash entrance door 20, which may be a curtain.

Referring to FIGS. 1 and 2, the car washing mechanism 48 comprises a touchless wash system 52, which includes a spray washer 7.

Referring to FIGS. 2a and 3, the car washing mechanism 48 comprises a friction wash system 54, which comprises a top cloth brush 29, two side cloth brushes 30 and a tire brush 31. The car wash compartment 6 further comprises a sensor 27 that senses whether the pallet 5 is secured in the car wash compartment 6. Referring to FIG. 3, reference numeral 13 indicates the pallet position inside the car wash compartment 6.

The car wash compartment 6 further comprises, a car wash drain catch basin 17, a car wash detergent tank 21 or container, a detergent mixer 22, a water tank 24, a pump assembly 23 for spraying water, a car wash control panel 25, an air compressor 26, and a water reclamation and filtration system 28.

A car wash equipment room 8 stores the car wash detergent tank 21, the detergent mixer 22, the water tank 24, the pump assembly 23, and the car wash control panel 25. The car wash compartment 6 is supported with a car wash steel structure 9, which is part of the steel structure of the automated parking structure 40.

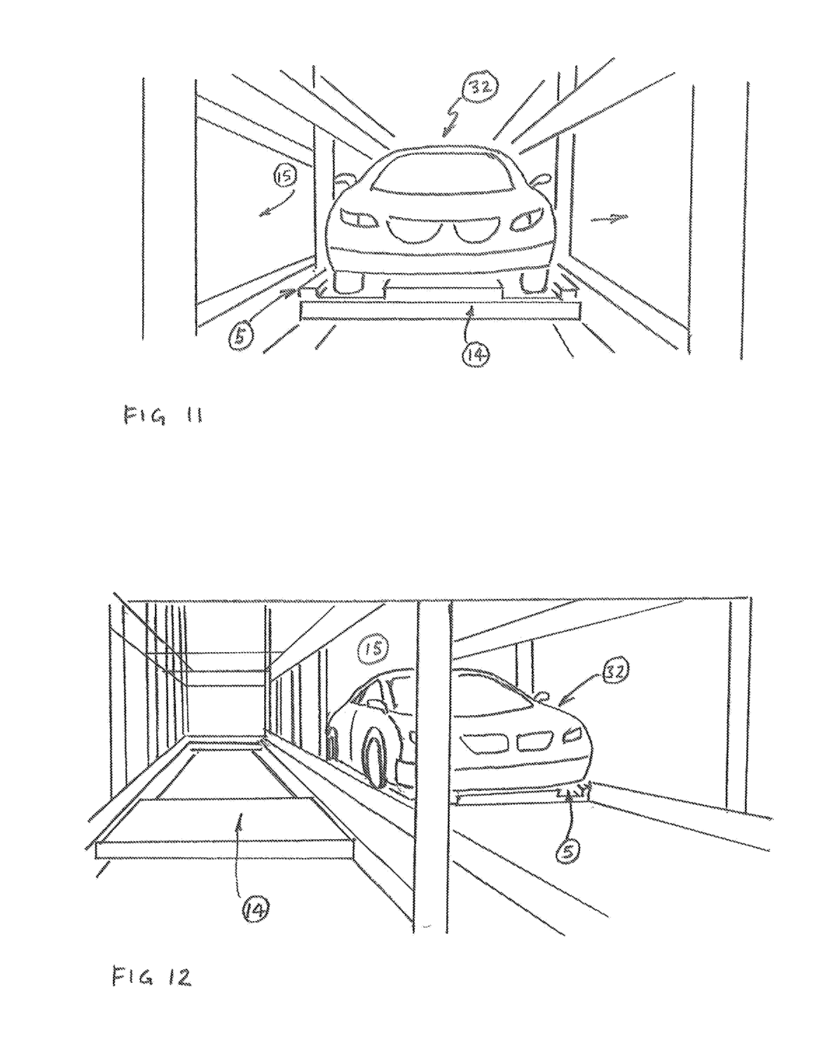

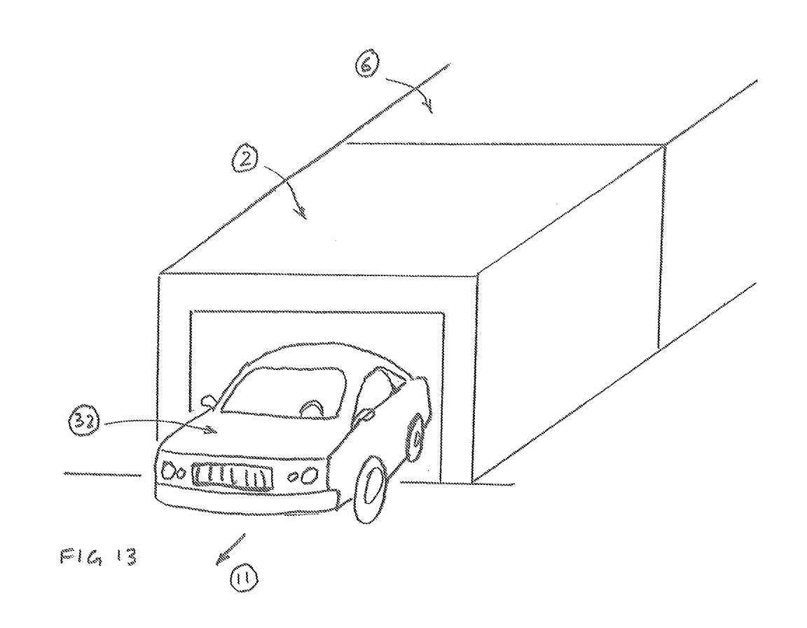

The operation sequence of the automated parking structure 40 is explained. The system is activated at the entry recognition panel by card key, key pad or any other security entry method (FIG. 5). A car enters the load bay (FIG. 5). The car is placed on the pallet (FIGS. 3 and 6) and has the option of parking the car normal way by transporting the car on the lift (10, FIGS. 3, 6, 10) to the designated level where the shuttle (FIGS. 11, 12) takes the car in the horizontal direction of shuttle way (16, FIG. 4, 11, 12) and puts the car into the car stall (FIGS. 4, 12) or it could be programmed at the entry point to be placed (4, FIG. 1) into the unmanned automatic car wash compartment (6, FIG. 2 or FIG. 2a). The car wash system could be Touchless (Brushless High Pressure) Wash System, FIG. 2 or Friction (Brush Type) Wash System, FIG. 2a. The car is placed in the car wash compartment (6,7,13, FIG. 2, 2a, 3) via pallet transfer mechanism (3, FIG. 3) on the cart transfer unit (14, FIG. 1, 3) where car wash is automatically activated and spray washes the car from the washing mechanism and dryer (7, FIG. 2, 2a, 8) supplied by washing agents from the car wash equipment room (8, FIG. 2, 2a, 3, 8). When the wash is finished, the car is transported back (4, FIG. 9) to the load bay (2, FIG. 9) to be parked in the designated parking stall (15, FIG. 10, 11, 12) using the same sequence as above. The car is retrieved at the entry recognition panel (1, FIG. 1, 3, 4) and exit from the load bay(s) (11, FIG. 13) same way as the normal retrieval of parked cars from the automated parking system.

Although the automated parking structure with integrated car wash system according to an exemplary embodiment of the present invention has been described in detail herein above, it should be understood that many variations and modifications of the basic inventive concept herein described, which may appear to those skilled in the art, will still fall within the spirit and scope of the exemplary embodiments of the present invention as defined by the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. An automated parking structure comprising:
a) a car load bay;
b) a plurality of parking stalls;
c) a car wash compartment;
d) a transport mechanism transporting a car to a designated location in the parking structure; and
e) a pallet that is adapted to carry a car thereon;
wherein the designated location comprises the car load bay, one of the parking stalls and the car wash compartment.

2. The automated parking structure of claim 1, wherein the transport mechanism comprises a horizontal transport device that transports the pallet horizontally, wherein the horizontal transport device moves the pallet into and out of the car wash compartment.

3. The automated parking structure of claim 2, wherein the transport mechanism further comprises a vertical transport device that transports the pallet vertically.

4. The automated parking structure of claim 3, wherein the car load bay comprises an entry recognition device that is adapted to recognize a car entering the automated parking structure, and to receive input from a driver of the car, wherein the input comprises a car cleaning command.

5. The automated parking structure of claim 4, wherein if the entry recognition device receives a car cleaning command, a sequence of the designated locations for the transport mechanism comprise a sequence of the car wash compartment, the parking stall and the load bay, or a sequence of the parking stall, the car wash compartment, the parking stall and the load bay, or a sequence of the parking stall, the car wash compartment and the load bay.

6. The automated parking structure of claim 5, wherein the sequence is determined depending on the availability of the car wash compartment and parking time of the car.

7. The automated parking structure of claim 5, wherein the sequence is determined by the input at the entry recognition device, whereby the driver of the car can choose the time of washing the car.

8. The automated parking structure of claim 5, wherein the transport mechanism starts to move the car toward the designated location after checking the occupant of the car exits out of the load bay.

9. The automated parking structure of claim 5, wherein the car wash compartment comprises a floor on which the pallet moves, a car washing mechanism and a drying mechanism, wherein a pallet track rail, along which the pallet moves, is provided on the floor.

10. The automated parking structure of claim 9, wherein the washing mechanism and the drying mechanism are spaced from the pallet when the pallet is in the car wash compartment whereby the washing mechanism and the drying mechanism do not interfere with the movement of the pallet.

11. The automated parking structure of claim 5, wherein the transport mechanism further comprises a shuttle on which the pallet is placed.

12. The automated parking structure of claim 11, wherein the car wash compartment further comprises a motor for driving the shuttle.

13. The automated parking structure of claim 12, wherein the car wash compartment further comprises a car wash entrance door.

14. The automated parking structure of claim 13, wherein the car washing mechanism comprises a touchless wash system.

15. The automated parking structure of claim 13, wherein the car washing mechanism comprises a friction wash system, which comprises a top cloth brush, two side cloth brushes and a tire brush.

16. The automated parking structure of claim 13, wherein the car wash compartment further comprises a sensor that senses whether the pallet is secured in the car wash compartment.

17. The automated parking structure of claim 16, wherein the car wash compartment further comprises a car wash detergent tank, a detergent mixer, a water tank, a pump assembly for spraying water, a car wash control panel, an air compressor, a water reclamation and filtration system.
